(19) United States
(12) Patent Application Publication
(10) Pub. No.: US 2024/0397970 A1
(43) Pub. Date: Dec. 5, 2024

(54) PRE-ACIDIFIED WHEY PROTEIN COMPOSITIONS AND METHODS OF MAKING

(71) Applicant: Leprino Foods Company, Denver, CO (US)

(72) Inventors: Richard K. Merrill, Highlands Ranch, CO (US); Jiancai Li, Denver, CO (US)

(21) Appl. No.: 18/207,006

(22) Filed: Jun. 7, 2023

Related U.S. Application Data
(63) Continuation of application No. 18/205,335, filed on Jun. 2, 2023.

(51) Int. Cl. A23J 3/08; A23J 1/20; A23L 2/02; A23L 33/19

(52) U.S. Cl. CPC A23J 3/08; A23J 1/205; A23L 2/02; A23L 33/19

(57) ABSTRACT

Methods of making undenatured pre-acidified whey protein isolates and protein-fortified beverages incorporating such undenatured pre-acidified whey protein isolates are described. Methods include ultrafiltering a liquid whey composition into a liquid whey protein retentate and a liquid whey permeate, and microfiltering the liquid whey protein retentate into a microfiltered whey protein retentate and a microfiltered whey protein permeate. Methods include reducing a pH of the microfiltered whey protein permeate to a pH of less than 3.8, forming a reduced pH whey protein permeate, and ultrafiltering and diafiltrating the reduced pH whey protein permeate into the undenatured pre-acidified whey protein isolate. Methods include optionally nanofiltering the undenatured pre-acidified whey protein isolate.

### CROSS REFERENCE TO RELATED APPLICATION

This application is a continuation of U.S. application Ser. No. 18/205,335, entitled “PRE-ACIDIFIED WHEY PROTEIN ISOLATE AND METHODS OF MAKING,” filed on Jun. 2, 2023, the contents of which are hereby incorporated by reference in their entirety and priority to the application is claimed to the full extent allowable under U.S. law and regulations.

### FIELD OF THE TECHNOLOGY

The present technology relates to pre-acidified whey protein isolates, including methods of producing such isolates. The present technology is also directed to low turbidity pre-acidified whey protein isolates and protein fortified beverages formed from such isolates.

### BACKGROUND

Powdered milk-derived products such as milk proteins, aldobionic products, and galactooligosaccharides, have become a major source of ingredients in a wide variety of foods and beverages. Milk-derived proteins, for example, have become a major source of protein-fortification in nutrition bars, protein mixes, sports drinks, and yogurt products. One source of milk proteins is the whey protein that is produced as a byproduct of cheese making. During cheesemaking, the casein proteins in the milk are formed into cheese curds while the liquid whey is drained from the curds and diverted for further processing. In most cheesemaking processes, the liquid whey is a mixture of whey proteins, small amounts of fat, and a significant amount of lactose and minerals, and the mixture undergoes additional purification to separate the whey proteins from the fat, lactose and minerals. Depending on the purification process and the extent of purification, whey protein concentrate (WPC) may be formed that concentrates the whey protein to 25-90 wt. % of protein as a percentage of the total weight of solids, or whey protein isolate (WPI) may be formed that concentrates the whey to 90-99 wt. % of protein as a percentage of the total weight of solids.

However, whey protein concentrates and isolates have proven difficult to incorporate into water-based beverages, such as fruit juices. Such beverages are often naturally acidic or subjected to an acidification process, in which the protein passes through its isoelectric points and can result in protein flocculation and cloudiness of the final product. In addition, many acidification processes can lead to the incorporation of undesired byproducts, such as ash and minerals, in the beverage. These and other challenges are addressed by the present technology.

### BRIEF SUMMARY

The present technology is generally directed to methods of making pre-acidified whey protein isolates. Methods include ultrafiltering a liquid whey composition into a liquid whey protein retentate and a liquid whey permeate. Methods include microfiltering the liquid whey protein retentate into a microfiltered whey protein retentate and a microfiltered whey protein permeate. Methods include reducing a pH of the microfiltered whey protein permeate to a pH that is less than an isoelectric point of the whey proteins, such as a pH of less than 3.8, forming a reduced pH whey protein permeate. Methods include ultrafiltering and diafiltrating the reduced pH whey protein permeate into a reduced pH whey protein isolate and a reduced pH permeate. In embodiments, methods include optionally nanofiltering or evaporating the reduced pH whey protein isolate prior to spray drying.

In embodiments, methods include spray drying the pre-acidified whey protein isolate to form a pre-acidified whey protein isolate powder. In more embodiments, the microfiltered whey protein permeate has a total solids content from about 1.5 wt. % to about 3.5 wt. %. In further embodiments, methods include reverse osmosing the microfiltered whey protein permeate prior to reducing the pH. In embodiments, the microfiltered whey protein permeate has a total solids content from about 3.5 wt. % to about 6 wt. %. Additionally or alternatively, in embodiments, the liquid whey composition is obtained from a cheesemaking process. In yet more embodiments, the ultrafiltering of the liquid whey composition does not include diafiltrating. In embodiments, the pH of the whey protein permeate is reduced to a pH of less than or about 3.5. In further embodiments, the pH of the whey protein permeate is reduced utilizing a food-grade acidulant.

Furthermore, in embodiments, methods include where the pre-acidified whey protein isolate includes greater than or about 18 wt. % solids. In more embodiments, the undenatured pre-acidified whey protein isolate includes greater than or about 90 wt. % protein on a dry basis. In embodiments, the undenatured pre-acidified whey protein isolate has a pH of less than or about 3.5. Moreover, in embodiments, the undenatured pre-acidified whey protein isolate includes less than or about 5 wt. % ash. In yet further embodiments, the undenatured pre-acidified whey protein isolate includes less than or about 2 wt. % minerals. Additionally or alternatively, in embodiments, the undenatured pre-acidified whey protein isolate includes from 0.5 wt. % to about 2 wt. % lactose. In more embodiments, the undenatured pre-acidified whey protein isolate exhibits a turbidity of less than or about 10 NTU at a solids content of greater than or about 15 wt. %.

The present technology is also generally directed to protein fortified beverages. In embodiments, the protein fortified beverage includes from about 2 wt. % to about 10 wt. % of an undenatured pre-acidified whey protein isolate according to any one or more of the above embodiments and water.

The present technology is also generally directed to methods of making protein fortified beverages. Methods include ultrafiltering a liquid whey composition into a liquid whey protein retentate and a liquid whey permeate. Methods include microfiltering the liquid whey protein retentate into a microfiltered whey protein retentate and a microfiltered whey protein permeate. Methods include reducing a pH of the microfiltered whey protein permeate to a pH of less than 3.8, forming a reduced pH whey protein permeate. Methods include ultrafiltering and diafiltrating the reduced pH whey protein permeate into a reduced pH concentrated whey protein isolate and a reduced pH liquid whey permeate. In embodiments, methods include optionally nanofiltering the reduced pH whey protein isolate to produce undenatured pre-acidified whey protein isolate. Methods include mixing the undenatured pre-acidified whey protein isolate (or optionally concentrated undenatured pre-acidified whey protein isolate) with a beverage.

In embodiments, methods include where the protein fortified beverage exhibits a turbidity of less than or about 30 NTU at a concentration of 5 wt. % protein in the protein fortified beverage. Method embodiments also include spray drying the undenatured pre-acidified whey protein isolate prior to mixing with water.

The present technology is also generally directed to protein fortified beverages. Beverages include from about 2 wt. % to about 10 wt. % of an undenatured pre-acidified whey protein isolate and water. Beverages include where the protein fortified beverage exhibits a turbidity of less than or about 30 NTU at a concentration of 5 wt. % protein in the protein fortified beverage.

Such technology may provide numerous benefits over conventional systems and methods. For example, the processes and systems may provide high-quality pre-acidified whey protein isolates with reduced processing system size, energy usage, and/or water usage. Additionally, the processes and systems may provide a pre-acidified whey protein isolate having a low pH, low ash, low mineral content, and an optimized lactose level. These and other embodiments, along with many of their advantages and features, are described in more detail in conjunction with the below description and attached figures.

### BRIEF DESCRIPTION OF THE DRAWINGS

A further understanding of the nature and advantages of selected embodiments of the present technology may be realized by reference to the remaining portions of the specification and the drawings wherein like reference numerals may be used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 shows selected operations in a formation method according to some embodiments of the present technology.

In the FIGURE, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

There is a desire in the industry to form protein fortified water-based beverages, such as fruit drinks, and sports waters fortified with protein. However, such beverages have proven challenging to formulate, as whey protein concentrates or isolates tend to exhibit negatively high turbidity (e.g., greater than 50 NTU at 5 wt. % whey protein isolate based upon the weight of the beverage) and/or precipitate from water-based beverages. Efforts to prevent turbidity and precipitation were attempted, such as reducing the pH of the beverage. However, by acidifying the beverage after inclusion of the whey protein concentrate or isolate, protein denaturation was exhibited, as well as high concentrations of ash from the acidification of the whey protein remaining in the beverage. In addition, the pH of the beverage is still often unacceptably high due to a pH buffering effect from the addition of the whey protein.

Efforts were made to pre-acidify whey protein concentrates and isolates, namely, acidification prior to incorporation into a beverage or food product. However, conventional methods still fail to remove the majority of the acidification byproducts, such as ash, due at least in part to insufficient filtration steps after acidification. Further, conventional processes have so far proven unsuccessful at providing high whey protein solids by weight, requiring additional drying energy or extensive processing to yield a concentrated whey protein isolate or dried concentrated whey protein isolate powder. Thus, such conventional processes waste large amounts of water necessary to process the whey protein isolate, which is undesirable for environmental concerns. Such high water waste also requires larger filtration processes in terms of total membrane area per weight of whey protein isolate produced, introducing further inefficiencies into the process.

The present technology overcomes these and other issues by providing undenatured pre-acidified whey protein isolates having a high purity and surprisingly low turbidity, as well as methods of making such undenatured pre-acidified whey protein isolates. The present technology has surprisingly found that by subjecting a liquid whey composition to specific processing steps in a predetermined order, undenatured pre-acidified whey protein isolates are provided that have a high purity, such as low levels of ash and other acidification byproducts, high weight percentages of solids, even prior to drying, such as spray drying, and high percentages by weight of undenatured protein on a dry basis. Moreover, in embodiments, the processes and methods discussed herein may be capable of forming such undenatured pre-acidified whey protein isolates by a highly efficient process. For instance, in embodiments of the present technology, less water may be utilized, resulting in water savings as well as a more highly concentrated undenatured pre-acidified whey protein isolate, which may further enable energy savings during any desired drying steps. In addition, by allowing for the use of more concentrated compositions in the method, the systems may be reduced in size, as less membrane filtration area, tanks, and connections may be utilized. Thus, processes and methods according to the present technology may improve the environmental impact of undenatured pre-acidified whey protein isolate processes as compared to conventional methods.

For instance, undenatured pre-acidified whey protein isolates according to the present technology may exhibit a pH of less than 3.8, such as less than or about 3.7, such as less than or about 3.6, such as less than or about 3.5, such as less than or about 3.4, such as less than or about 3.3, such as less than or about 3.2, such as less than or about 3.1, such as less than or about 3, such as less than or about 2.9, such as less than or about 2.8, such as less than or about 2.7, such as less than or about 2.6, such as down to a pH of about 2.5, or any ranges or values therebetween.

Furthermore, such undenatured pre-acidified whey protein isolates may have a concentration prior to drying of greater than or about 15 wt. % total solids, such as greater than or about 16 wt. %, such as greater than or about 17 wt. %, such as greater than or about 18 wt. %, such as greater than or about 19 wt. %, such as greater than or about 20 wt. %, such as greater than or about 21 wt. %, such as greater than or about 22 wt. %, such as greater than or about 23 wt. %, such as greater than or about 24 wt. %, such as greater than or about 25 wt. %, such as greater than or about 26 wt. %, such as greater than or about 27 wt. %, such as greater than or about 28 wt. %, such as greater than or about 29 wt. %, such as greater than or about 30 wt. %, such as greater than or about 31 wt. %, such as greater than or about 32 wt. % total solids prior to drying, which will be discussed in greater detail below, or any ranges or values therebetween.

Moreover, at such total solids weight percentages, the undenatured pre-acidified whey protein isolates may have a total weigh percent of protein on a dry basis of greater than or about 90 wt. %, such as greater than or about 91 wt. %, such as greater than or about 92 wt. %, such as greater than or about 93 wt. %, such as greater than or about 94 wt. %, such as greater than or about 95 wt. %, such as greater than or about 96 wt. %, such as greater than or about 97 wt. %, such as greater than or about 98 wt. %, such as greater than or about 99 wt. %, or any ranges or values therebetween.

Surprisingly, in embodiments, undenatured pre-acidified whey protein isolates according to the present technology exhibit a low turbidity even at high solids contents, such as any one or more of the above weight percentages of solids. For instance, in embodiments, undenatured pre-acidified whey protein isolates according to the present technology exhibit a turbidity of less than or about 15 NTU at a solids content of greater than or about 15 wt. % (e.g., turbidity prior to drying), such as less than or about 14 NTU, such as less than or about 13 NTU, such as less than or about 12 NTU, such as less than or about 11 NTU, such as less than or about 10 NTU, such as less than or about 9 NTU, such as less than or about 8 NTU, such as less than or about 7 NTU, such as less than or about 6 NTU, such as less than or about 5 NTU, such as less than or about 4 NTU, or any ranges or values therebetween.

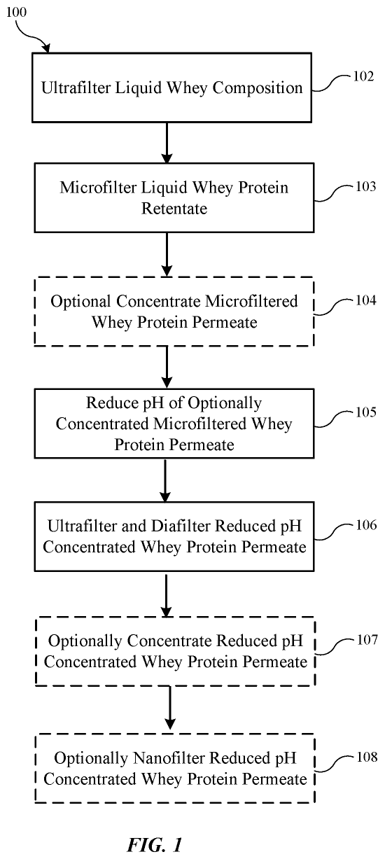

FIG. 1 shows exemplary operations in a method 100 according to some embodiments of the present technology. The method may be performed in a variety of processing apparatus as known in the art. Method 100 may include a number of optional operations, which may or may not be specifically associated with some embodiments of methods according to the present technology. For example, many of the operations are described to provide a broader scope of the composition formation, but are not critical to the technology, or may be performed by alternative methodology as would be readily appreciated.

Undenatured pre-acidified whey protein isolates and protein fortified beverages containing such undenatured pre-acidified whey protein isolates are described that incorporate one or more sources of whey protein, such as natural whey proteins. In embodiments, these proteins may be the exclusive sources of protein incorporated into the beverage. Exemplary liquid whey compositions utilized as a starting material herein may include undenatured milk proteins sourced directly from pasteurized or unpasteurized milk from one or more ruminants, such as bovine milk. These undenatured milk proteins may include native whey proteins, native casein proteins, or a combination of both types of proteins. In some embodiments, the one or more of the native whey proteins may have a concentration profile that is the same as, or similar to, the concentration profile in an unprocessed, starting bovine milk. In additional embodiments, the native whey proteins may have a different concentration profile than their concentration profile in the unprocessed, starting bovine milk.

In embodiments, the liquid whey composition utilized herein may be obtained from a cheesemaking process. In some embodiments, the liquid whey composition may be generated from the cheesemaking process and may be referred to as “sweet whey” when the cheesemaking process uses rennet enzymes like chymosin, and “acid whey” when acids are used to form the curds. The pH of sweet whey typically ranges from about 5.6 to 6.6, while the pH of acid whey typically ranges from 4.3 to 4.6. For instance, in some embodiments, the liquid whey composition may be a raw whey mixture separated from cheese curd having a protein composition of 5 wt. % protein or greater, on a dry weight basis, such as about 10 wt. % or greater, such as about 13 wt. % or less, or any ranges or values therebetween.

Moreover, in embodiments, the liquid whey composition may have undergone one or more pretreatment steps. For instance, in embodiments, a starting liquid whey, such as a starting liquid whey separated from cheese curd as an example, may undergo one or more of clarification to remove cheese fines, separation to remove fat, pasteurization, or the like, as known in the art.

Regardless of the starting liquid whey composition the present technology has surprisingly found that by utilizing an ultrafiltering step, without diafiltrating, first, followed by a microfiltering step, a much small microfiltration system in terms of total membrane surface is required, then when starting with a microfiltering step. For instance, in processes according to the present technology, a microfilter may have a total membrane surface area of less than or about 600 square meters (m²) per 1,000 pounds of protein in the liquid whey composition (e.g., protein in the liquid feed material), such as less than or about 575 m², such as less than or about 550 m², such as less than or about 525 m², such as less than or about 500 m², such as less than or about 475 m², such as less than or about 450 m², such as less than or about 425 m², such as less than or about 400 m² , such as less than or about 375 m², such as less than or about 350 m², such as less than or about 325 m², such as less than or about 300 m², such as less than or about 275 m², such as less than or about 250 m², such as less than or about 225 m², such as less than or about 200 m² of total membrane surface area per 1,000 pounds of protein in the liquid whey composition, or any ranges or values therebetween.

Conversely, microfiltration system (membrane area) would need to have a significantly larger surface area, such as greater than 3 times the size of the microfiltration system of the present technology in order to process the starting liquid whey volume without an initial ultrafiltration operation. Namely, conventional systems beginning with microfiltration prior to ultrafiltration require membrane surface areas of greater than 650 m² per 1,000 pounds of whey protein isolate processed. Thus, the present technology allows for a high throughput process without increased inputs that requires less wastage, such as lower water usage, providing a more environmentally conscious process.

For instance, in embodiments, the starting liquid whey according to the present technology may have a weight of total solids of greater than or about 2.5 wt. %, such as greater than or about 3 wt. %, such as greater than or about 3.5 wt. %, such as greater than or about 4 wt. %, such as greater than or about 4.5 wt. %, such as greater than or about 5 wt. %, such as greater than or about 5.5 wt. %, such as greater than or about 6 wt. %, such as greater than or about 7 wt. %, based upon the weight of the liquid whey composition, or any ranges or values therebetween.

Thus, embodiments of the method 100 include a first ultrafiltration operation 102 of the starting liquid whey without diafiltration. In embodiments, an ultrafiltration membrane utilized at operation 102 may be any ultrafiltration membrane as known in the art. For instance, in embodiment, the ultrafiltration membrane may have pores with a pore diameter of about 10 kDa or less, such as less than or about 9 kDa, such as less than or about 8 kDa, such as less than or about 7 kDa, such as less than or about 6 kDa, such as about 5 kDa or greater, or any ranges or values therebetween. Notwithstanding the ultrafilter material and pore size, the ultrafiltration operation 102 serves to separate the liquid whey composition into a liquid whey protein retentate and a liquid whey permeate containing lactose and minerals.

After ultrafiltration operation 102, the liquid whey protein retentate may contain greater than or about 5 wt. % total solids, such as greater than or about 5.2 wt. %, such as greater than or about 5.4 wt. %, such as greater than or about 5.6 wt. %, such as greater than or about 5.8 wt. %, such as greater than or about 6 wt. %, such as greater than or about 6.2 wt. %, such as greater than or about 6.4 wt. %, such as greater than or about 6.6 wt. %, such as greater than or about 6.8 wt. %, such as greater than or about 7 wt. %, such as greater than or about 7.2 wt. %, such as greater than or about 7.5 wt. %, based upon the weight of the liquid whey composition, or any ranges or values therebetween.

Moreover, the liquid whey protein retentate may contain greater than or about 1 wt. % protein, based upon the weight of the liquid whey protein retentate, such as greater than or about 1.25 wt. %, such as greater than or about 1.5 wt. %, such as greater than or about 1.75 wt. %, such as greater than or about 2 wt. %, such as greater than or about 2.25 wt. %, or any ranges or values therebetween. Stated differently, in embodiments, the liquid whey protein retentate may contain a weight of protein of greater than or about 25 wt. % protein on a dry weight basis, such as greater than or about 27.5 wt. %, such as greater than or about 30 wt. %, such as greater than or about 32.5 wt. %, such as greater than or about 35 wt. %, such as greater than or about 37.5 wt. %, such as greater than or about 40 wt. %, or any ranges or values therebetween.

Nonetheless, the liquid whey protein retentate is then subjected to microfiltration at operation 103 that can include diafiltration. Due to the increased solids concentration and/or protein concentration from conducting ultrafiltration as the first operation 102, a smaller surface area microfiltration membrane and/or less water is utilized, leading to a more efficient process with higher solids content than if utilizing a different order of filtration steps. In embodiments, a microfiltration membrane utilized at operation 103 may be any polymeric or ceramic microfiltration membrane as known in the art. The microfiltration membrane may have a pore size of less than or about 0.3 μm, such as less than or about 0. 25 μm, such as less than or about 0.2 μm, such as less than or about 0.15 μm, such as down to about 0.1 μm or greater, or any ranges or values therebetween. Stated differently, the microfiltration membrane may have a pore diameter of about 400 kDa to about 3,250 kDa, such as from about 450 kDa to about 3,100 kDa, such as from about 500 kDa to about 3,000 kDa, or any ranges or values therebetween. Notwithstanding the microfilter material and pore size, the microfiltration operation 103 serves to separate the liquid whey protein retentate into a microfiltered whey protein retentate and a microfiltered whey protein permeate.

Advantageously, microfiltration operation 103 separates the undenatured whey proteins from denatured proteins and fats. Thus, as the liquid whey composition according to the present technology undergoes pasteurization and clarification prior to ultrafiltering operation 102, the microfiltered whey protein permeate contains predominantly undenatured whey proteins and does not require additional pasteurization or germ filtration operations. Therefore, in embodiments, no germ filtration or membranes may be necessary in the methods and processes of the present technology. In addition, in embodiments, as pasteurization is conducted prior to ultrafiltration operation 102 and microfiltration operation 103, no shielding agents or other protective agents to prevent denaturation may be necessary or included in the undenatured pre-acidified whey protein isolate.

Nonetheless, in embodiments, the microfiltered whey protein permeate may have a weight of total solids, based upon the weight of the microfiltered whey protein permeate, of greater than or about 1.5 wt. %, such as greater than or about 1.75 wt. %, such as greater than or about 2 wt. %, such as greater than or about 2.25 wt. %, such as greater than or about 2.5 wt. %, such as greater than or about 2.75 wt. %, such as greater than or about 3 wt. %, or any ranges or values therebetween.

In embodiments, it may be advantageous to subject the microfiltered whey protein permeate to one or more optional concentration operations 104 to further concentrate the microfiltered whey protein permeate. Thus, an optional concentration operation 104 may include one or more reverse osmosis operations or nanofiltration operations. In embodiments, any reverse osmosis or nanofiltration apparatus as known in the art may be utilized. The microfiltered whey protein permeate may be optionally concentrated one time, two times, three times, four times, five times, or more, and/or at a specific concentration factor, as desired to obtain the desired concentration.

Additionally or alternatively, in embodiments, the optional concentration operation 104 may be conducted at a specific concentration factor to provide an optionally concentrated microfiltered whey protein permeate having a total solids of greater than or about 3 wt. % based upon the weight of the optionally concentrated microfiltered whey protein permeate, such as greater than or about 3.25 wt. %, such as greater than or about 3.5 wt. %, such as greater than or about 3.75 wt. %, such as greater than or about 4 wt. %, such as greater than or about 4.25 wt. %, such as greater than or about 4.5 wt. %, such as greater than or about 4.75 wt. %, such as greater than or about 5 wt. %, such as greater than or about 5.25 wt. %, such as greater than or about 5.5 wt. %, such as greater than or about 5.75 wt. %, such as greater than or about 6 wt. %, or any ranges or values therebetween.

Regardless of whether optional concentration steps are conducted, the optionally concentrated microfiltered whey protein permeate may be acidified at pH reduction operation 105. The pH reduction may be conducted utilizing a food grade acidulant, or other methods as known in the art. In embodiments, any suitable food grade acidulant may be utilized, such as citric acid, malic acid, phosphoric acid, glucono-delta-lactone acid, hydrochloric acid, lactic acid, fumaric acid, tartaric acid, acetic acid, adipic acid, carbonic acid, or combinations thereof. Other acidulants known to those of skill in the art also may be used, such as one or more other food-grade acids.

In any case, the microfiltered whey protein permeate may have an initial pH, which is reduced to a pH of less than 3.8, such as less than or about 3.7, such as less than or about 3.6, such as less than or about 3.5, such as less than or about 3.4, such as less than or about 3.3, such as less than or about 3.2, such as less than or about 3.1, such as less than or about 3, such as less than or about 2.9, such as less than or about 2.8, such as less than or about 2.7, such as less than or about 2.6, such as down to a pH of about 2.5, or any ranges or values therebetween, using a food grade acidulant, at operation 105.

While various acidulants and amounts may be utilized at operation 105, it should be clear that the pH reducing operation 105 according to the present technology must occur prior to at least one filtration step. Namely, by acidifying after an initial ultrafiltration and microfiltration step, but prior to at least one further filtration step, a targeted pH may be achieved while removing significantly all of the ash and byproducts formed during the acidification operation. Thus, the undenatured pre-acidified whey protein isolate may have a targeted pH level as well as low enough levels of ash to be a whey protein isolate (e.g., greater than 90 wt. % protein) as compared to conventional concentrates containing too much ash to qualify as an isolate.

Thus, the present technology includes a further ultrafiltration operation 106 that can include diafiltration, forming an undenatured pre-acidified whey protein isolate. In embodiments, the ultrafilter may be the same or different than the ultrafilter discussed in regards to operation 102. Nonetheless, in embodiments, the ultrafilter of operation 106 may use any one or more of the ultrafilter membrane materials and pore sizes discussed above.

Notwithstanding the ultrafilter utilized, the undenatured pre-acidified whey protein isolate may have an advantageously high concentration of solids and protein prior to a drying operation. For instance, in embodiments, the undenatured pre-acidified whey protein isolate may contain greater than or about 12 wt. % total solids, such as greater than or about 13 wt. %, such as greater than or about 14 wt. %, such as greater than or about 15 wt. %, such as greater than or about 16 wt. %, such as greater than or about 16.5 wt. %, such as greater than or about 17 wt. %, such as greater than or about 17.5 wt. %, such as greater than or about 18 wt. %, such as greater than or about 18.5 wt. %, such as greater than or about 19 wt. %, such as greater than or about 19.5 wt. %, such as greater than or about 20 wt. %, such as greater than or about 25 wt. %, or any ranges or values therebetween.

Moreover, the undenatured pre-acidified whey protein isolate may contain greater than or about 12 wt. % protein, based upon the weight of the reduced pH whey protein isolate prior to drying (e.g. not on a dry basis), such as greater than or about 13 wt. %, such as greater than or about 14 wt. %, such as greater than or about 15 wt. %, such as greater than or about 16 wt. %, such as greater than or about 16.5 wt. %, such as greater than or about 17 wt. %, such as greater than or about 17.25 wt. %, or any ranges or values therebetween. Stated differently, in embodiments, the undenatured pre-acidified whey protein isolate may contain a weight of protein of greater than or about 80 wt. % protein on a dry weight basis, such as greater than or about 82.5 wt. %, such as greater than or about 85 wt. %, such as greater than or about 87.5 wt. %, such as greater than or about 90 wt. %, or any ranges or values therebetween.

Nonetheless, in embodiments, the undenatured pre-acidified whey protein isolate may undergo an optional concentration operation 107 to form an optionally concentrated undenatured pre-acidified whey protein isolate. In embodiments, the optional concentration operation 107 may include nanofiltration. When nanofiltration is utilized, the nanofilter may be any polymeric membrane as known in the art. In embodiments, such a nanofilter may have a pore diameter of less than or about 300 Da, such as less than or about 275 Da, such as less than or about 250 Da, such as less than or about 225 Da, such as less than or about 200 Da, such as less than or about 175 Da, such as about 150 Da or greater, or any ranges or values therebetween.

After optional concentration operation 107, the optionally concentrated undenatured pre-acidified whey protein isolate may contain greater than or about 20 wt. % total solids, such as greater than or about 21 wt. %, such as greater than or about 22 wt. %, such as greater than or about 23 wt. %, such as greater than or about 24 wt. %, such as greater than or about 25 wt. %, such as greater than or about 26 wt. %, such as greater than or about 27 wt. %, such as greater than or about 28 wt. %, such as greater than or about 29 wt. %, such as greater than or about 30 wt. %, such as greater than or about 31 wt. %, such as greater than or about 32 wt. %, such as greater than or about 35 wt. %, such as greater than or about 40 wt. %, such as greater than or about 45 wt. %, such as greater than or about 50 wt. %, or any ranges or values therebetween.

Moreover, the optionally concentrated undenatured pre-acidified whey protein isolate may contain greater than or about 18 wt. % protein, based upon the weight of the optionally concentrated undenatured pre-acidified whey protein isolate prior to drying (e.g. not on a dry basis), such as greater than or about 19 wt. %, such as greater than or about 20 wt. %, such as greater than or about 21 wt. %, such as greater than or about 22 wt. %, such as greater than or about 23 wt. %, such as greater than or about 24 wt. %, such as greater than or about 25 wt. %, such as greater than or about 25.5 wt. %, or any ranges or values therebetween. Stated differently, in embodiments, the optionally concentrated undenatured pre-acidified whey protein isolate (e.g. before or after concentration, if necessary) may contain a weight of protein of greater than or about 80 wt. % protein on a dry weight basis, such as greater than or about 85 wt. %, such as greater than or about 87.5 wt. %, such as greater than or about 90 wt. %, such as greater than or about 91 wt. %, such as greater than or about 92 wt. %, such as greater than or about 93 wt. %, or any ranges or values therebetween.

Surprisingly, even at concentrated levels, the undenatured pre-acidified whey protein isolate exhibits a turbidity in the undenatured pre-acidified whey protein isolate solution (e.g. prior to drying), of any one or more of the turbidity values discussed above, such as a turbidity of less than or about 15 NTU at a solids content of greater than or about 15 wt. %, such as less than or about 14 NTU, such as less than or about 13 NTU, such as less than or about 12 NTU, such as less than or about 11 NTU, such as less than or about 10 NTU, such as less than or about 9 NTU, such as less than or about 8 NTU, such as less than or about 7 NTU, such as less than or about 6 NTU, such as less than or about 5 NTU, such as less than or about 4 NTU, or any ranges or values therebetween.

Notwithstanding the final weight of total solids and proteins, the optionally concentrated undenatured pre-acidified whey protein isolate may be dried at operation 108 to produce an undenatured pre-acidified whey protein isolate powder. Drying processes may include spray drying, heating, and evaporation, among other processes. The drying process may remove a majority of the water, which may be significantly less than other processes due to the highly efficient and concentrated process.

In embodiments, the drying process may remove water such that the optionally concentrated undenatured pre-acidified whey protein isolate powder contains less than or about 10 wt. % water, such as less than or about 9 wt. %, such as less than or about 8 wt. %, such as less than or about 7 wt. %, such as less than or about 6 wt. %, such as less than or about 5 wt. %, such as less than or about 4 wt. %, such as less than or about 3 wt. %, or any ranges or values therebetween.

Thus, in embodiments, the undenatured pre-acidified whey protein isolate powder may contain greater than or about 90 wt. % total solids, such as greater than or about 91 wt. %, such as greater than or about 92 wt. %, such as greater than or about 93 wt. %, such as greater than or about 94 wt. %, such as greater than or about 95 wt. %, such as greater than or about 96 wt. % total solids. Moreover, as discussed above, such total solid levels are achievable with less drying energy that a process that does not include an ultrafiltration step prior to a microfiltration operation, as the total solids is increased throughout the process prior to drying.

Surprisingly, due to the order of filtration steps, the undenatured pre-acidified whey protein isolate according to the present technology exhibits low concentrations of ash, minerals, fats, and lactose. For instance, in embodiments, the undenatured pre-acidified whey protein isolate contains less than or about 2 wt. % lactose based on the total weight of solids in the undenatured pre-acidified whey protein isolate, such as less than or about 1.8 wt. %, such as less than or about 1.6 wt. %, such as less than or about 1.4 wt. %, such as less than or about 1.2 wt. %, such as less than or about 1 wt. %, such as less than or about 0.8 wt. %, such as less than or about 0.7 wt. %, such as less than or about 0.6 wt. %, such as greater than 0.5 wt. %, or any ranges or values therebetween.

In addition, in embodiments, undenatured pre-acidified whey protein isolates according to the present technology may have a weight percentage of ash, based upon the weight of solids in the undenatured pre-acidified whey protein isolate of less than or about 9 wt. %, such as less than or about 8 wt. %, such as less than or about 7 wt. %, such as less than or about 6 wt. %, such as less than or about 5 wt. %, such as less than or about 4 wt. %, such as less than or about 3 wt. %, such as less than or about 2 wt. %, such as less than or about 1 wt. %, or any ranges or values therebetween.

Similarly, in embodiments, undenatured pre-acidified whey protein isolates according to the present technology may have a weight percentage of fat, based upon the weight of solids in the undenatured pre-acidified whey protein isolate of less than or about 2 wt. %, such as less than or about 1.5 wt. %, such as less than or about 1 wt. %, such as less than or about 0.9 wt. %, such as less than or about 0.8 wt. %, such as less than or about 0.7 wt. %, such as less than or about 0.6 wt. %, such as less than or about 0.5 wt. %, such as less than or about 0.4 wt. %, such as less than or about 0.35 wt. % or any ranges or values therebetween.

Moreover, in embodiments, the undenatured pre-acidified whey protein isolates according to the present technology may have a weight percentage of electrolytes, also referred to as minerals, based upon the weight of solids in the undenatured pre-acidified whey protein isolate of less than or about 3 wt. %, such as less than or about 2.5 wt. %, such as less than or about 2 wt. %, such as less than or about 1.9 wt. %, such as less than or about 1.8 wt. %, such as less than or about 1.7 wt. %, such as less than or about 1.6 wt. %, such as less than or about 1.5 wt. %, or any ranges or values therebetween.

For instance, the undenatured pre-acidified whey protein isolates may be low in sodium. For example, the undenatured pre-acidified whey protein isolates may contain less than 0.1 wt. % sodium based on the total weight of the undenatured pre-acidified whey protein isolates, such as less than or about 0.08 wt. %, such as less than or about 0.06 wt. %, such as less than or about 0.05 wt. %, such as less than or about 0.04 wt. %, such as less than or about 0.03 wt. %, such as less than or about 0.02 wt. %, such as less than or about 0.01 wt. %, or any ranges or values therebetween.

In addition, the undenatured pre-acidified whey protein isolates may be low in potassium. For example, the undenatured pre-acidified whey protein isolates may contain less than 0.1 wt. % potassium based on the total weight of the undenatured pre-acidified whey protein isolates, such as less than or about 0.08 wt. %, such as less than or about 0.06 wt. %, such as less than or about 0.05 wt. %, such as less than or about 0.04 wt. %, such as less than or about 0.03 wt. %, such as less than or about 0.02 wt. %, or any ranges or values therebetween.

Additionally or alternatively, the undenatured pre-acidified whey protein isolates may be low in calcium. For example, the undenatured pre-acidified whey protein isolates may contain less than 0.1 wt. % calcium based on the total weight of the undenatured pre-acidified whey protein isolates, such as less than or about 0.08 wt. %, such as less than or about 0.06 wt. %, such as less than or about 0.05 wt. %, such as less than or about 0.04 wt. %, such as less than or about 0.03 wt. %, or any ranges or values therebetween.

Nonetheless, as discussed above, the undenatured pre-acidified whey protein isolate powder may then be packaged or added directly to other ingredients, or added directly to a food or beverage, for making a protein fortified food or beverage composition.

An exemplary protein fortified beverage may include water, an undenatured pre-acidified whey protein isolate, one or more carbohydrates, one or more acidification agents, and one or more flavoring agents. However, as discussed above, in embodiments, a protein fortified food or beverage as discussed herein may not include any additional acidification agent, as the undenatured pre-acidified whey protein isolate is already in acidified form prior to incorporation. Nonetheless, in embodiments, the protein fortified food or beverage may include one or more of a probiotic, a botanical, a fruit ingredient, a vegetable ingredient, caffeine, and collagen.

Water may constitute greater than or about 70 wt. % of a protein fortified beverage based upon the total weight of the protein fortified beverage, such as greater than or about 86 wt. %, such as greater than or about 87 wt. %, such as greater than or about 88 wt. %, such as greater than or about 89 wt. %, such as greater than or about 90 wt. %, such as greater than or about 91 wt. %, such as greater than or about 92 wt. %, such as greater than or about 93 wt. %, such as greater than or about 94 wt. %, such as greater than or about 95 wt. %, such as greater than or about 96 wt. %, such as greater than or about 97 wt. %, or any ranges or values therebetween.

The undenatured pre-acidified whey protein isolate may constitute greater than or about 2 wt. % of a protein fortified food or beverage, based upon the total weight of the protein fortified food or beverage, such as greater than or about 3 wt. %, such as greater than or about 4 wt. %, such as greater than or about 5 wt. %, such as greater than or about 6 wt. %, such as greater than or about 7 wt. %, such as greater than or about 8 wt. %, such as greater than or about 9 wt. %, such as greater than or about 10 wt. %, such as greater than or about 15 wt. %, such as greater than or about 20 wt. %, or any ranges or values therebetween (e.g., 2 wt. % to 20 wt. %).

The one or more carbohydrates may constitute greater than or about 0.01 wt. % of a protein fortified food or beverage, based upon the total weight of the protein fortified food or beverage, such as greater than or about 0.05 wt. %, such as greater than or about 0.1 wt. %, such as greater than or about 0.15 wt. %, such as greater than or about 0.2 wt. %, such as greater than or about 0.25 wt. %, such as greater than or about 0.5 wt. %, such as greater than or about 1 wt. % or any ranges or values therebetween.

The protein fortified food or beverage may include sodium, potassium, and calcium supplied by the above-listed ingredients or by an additional composition. For example, in embodiments, the only sodium, potassium, and/or calcium included may be supplied by the undenatured pre-acidified whey protein isolate. In embodiments, however, additional compounds may be included, such as sodium citrate, which may function to provide sodium as well as flavoring, but may be present in levels that do not affect the pH of the protein fortified food or beverage.

Regardless of the additional ingredients, as an example of forming a protein fortified beverage, water or a pre-mixed beverage and the undenatured pre-acidified whey protein isolate are combined to form a protein fortified beverage. The method may further include combining additional ingredients with the aqueous mixture of the undenatured pre-acidified whey protein isolate and water or a pre-mixed beverage to form an intermediate beverage mixture. These additional ingredients may include one or more of flavor agents, color agents, and sweetening agents, among other types of ingredients. The intermediate beverage mixture may optionally be stirred for a predetermined period (e.g., 10-60 minutes) to permit that the undenatured pre-acidified whey protein isolate and additional ingredients time to hydrate and optionally homogenized to form a homogenized beverage mixture. Homogenization of the intermediate beverage mixture may be conducted in a two-stage homogenization process that includes a first, higher-pressure stage (e.g., 2000 psi) and a second, lower-pressure stage (e.g., 500 psi).

While hydration and homogenization may not be necessary, in embodiments, the intermediate beverage mixture may be heat treated. Exemplary heat treatment conditions (e.g., pasteurization conditions, in embodiments) may include pasteurization temperatures ranging from 190° F. to 220° F. and pasteurization times ranging from 5-60 seconds, or any other times and temperatures as known in the art. The pasteurized, protein fortified beverage may be bottled to form the final, protein fortified beverage. The pasteurized, protein-containing beverage may be injected into the bottles at a hot temperature (e.g., 175-193° F.) with the bottling stage marking the end of the pasteurization of the protein fortified beverage. In embodiments, an orifice of the bottle representing a critical control point (CCP) may be kept at a temperature greater than 175° F. while the bottle is being filled to prevent the introduction of food spoilage microorganisms and/or other contaminants. In other embodiments the protein fortified beverage may be concentrated for packaging and shipping as a reduced-water concentrate.

Surprisingly, as discussed above, undenatured pre-acidified whey protein isolates may also exhibit excellent turbidity when included in a protein fortified beverage, which will be discussed in greater detail below. For instance, in embodiments, undenatured pre-acidified whey protein isolates according to the present technology may be incorporated into a beverage, where the beverage has a turbidity of less than or about 50 NTU at a concentration of 5 wt. % protein in the protein fortified beverage, such as less than or about 45 NTU, such as less than or about 40 NTU, such as less than or about 35 NTU, such as less than or about 30 NTU, such as less than or about 28 NTU, such as less than or about 26 NTU, such as less than or about 24 NTU, such as less than or about 22 NTU, such as less than or about 20 NTU, such as less than or about 18 NTU, such as less than or about 16 NTU, such as less than or about 14 NTU, such as less than or about 12 NTU, such as less than or about 10 NTU, such as less than or about 8 NTU, such as less than or about 6 NTU, such as less than or about 4 NTU, such as less than or about 2 NTU, such as less than or about 1 NTU, or any ranges or values therebetween.

Nonetheless, it should be clear that, in embodiments, the undenatured pre-acidified whey protein isolate, including the undenatured pre-acidified whey protein isolate powder, may be incorporated into other foods and beverages that would benefit from the high quality, high purity, low turbidity, undenatured pre-acidified whey protein isolates according to the present technology.

Furthermore, certain embodiments of the present disclosure may be better understood according to the following examples, which are intended to be non-limiting and exemplary in nature.

### EXAMPLES

### Test Methods

Turbidity of pre-acidified whey protein isolate was measured using a benchtop turbidity meter (HACH 2100N Turbidimeter, Loveland, CO).
A. Turn on turbidity meter and calibrate with standard turbidity solutions
B. Make protein solution
   i. g powder=(50×protein concentration of solution)/“as is” protein in powder
   ii. g water=50−g powder
   iii. Mix powder and water in a 100 mL beaker and stir on a stir plate until no clumps remain
   iv. Once foam settles, pour into turbidity tubes
C. Allow sample to rest for 2 hours before placing in turbidity meter.
D. Place in turbidity meter and record result.

Heat stability of pre-acidified whey protein isolate was evaluated at 95° C. in a oil bath.
A. Make protein solution
   i. g powder=(50×protein concentration in solution)/“as is” protein in powder
   ii. g water=50−g powder
   iii. Mix powder and water in a 100 mL beaker and stir on a stir plate until no clumps remain
B. Pipette 10 mL of solution into each of two test tubes. Insert septum stoppers and seal with aluminum seals and crimper.
C. Place the test tubes into the 95° C. oil bath, holding one tube for 10 minutes and the other tube for 20 minutes. The oil level must be at least ½ inch above the level of solution in the tubes.
D. Remove the tubes from the oil bath, wipe off excess oil and immediately tilt the tube to a 45° angle; against a light source invert the tube 180°.
E. After 10 minutes remove the tubes from the ice bath keeping the tube at a 45° angle; against a light source invert the tube 180°.
F. Observe the leading edge of the solution for any precipitate, flocks, thickening (gelling), or particles. Invert the tubes only once, as the precipitate will quickly return to solution if the tube is tilted several times. There is likely to be a thin gel layer at the top of the solution, this is normal, and the tube may need to be gently shaken to break the gel layer allowing the solution to flow.
G. Record the results. No precipitate, thickening, gelation (except for top layer) passes. Report the greatest time passed.

### Example 1

Pre-acidified whey protein isolate (WPI) was made from cheese whey that was a by-product of mozzarella cheese making. Pasteurized raw skim whey separated from cheese curd with about 6% total solids (12.5% protein on dry basis) was used as the liquid whey composition, and was clarified (removal of cheese fines), separated (removal of fat), and pasteurized (165° F. for approximately 15 seconds). The pasteurized skim whey was subjected to a first ultrafiltration (UF1) with no diafiltration (DF) to produce a liquid whey protein retentate (UF1 retentate, 35 wt. % protein on dry basis), which was further processed through microfiltration (MF) with DF to produce a MF retentate and a MF permeate. The MF permeate (2.5% TS, 0.8% protein) was optionally concentrated 2× using reverse osmosis (RO) forming an optionally concentrated microfiltered whey protein permeate (5.0% total solids (TS), 1.6% protein, RO retentate if concentrated). The optionally concentrated microfiltered whey protein permeate was acidified to pH 2.8 using phosphoric acid. In this example, 75% phosphoric acid was used for acidification and injected at a dosage level of about 0.8% by weight of the optionally concentrated microfiltered whey protein permeate via an acid injection system. For an optionally concentrated microfiltered whey protein permeate with a flow rate of 5,000 pph, the dosage rate of 75% phosphoric acid is about 40 pph. The reduced pH concentrated whey protein permeate was then processed through a second ultrafiltration (UF2) with DF to produce a reduced pH concentrated whey protein isolate (UF2 retentate, pH ˜3.1) with ˜19 wt. % total solids (TS) and ˜91 wt. % protein on dry basis (PDB), and a turbidity less than or about 10 NTU. The resulting reduced pH concentrated whey protein isolate was subjected to optional concentration to 28 wt. % TS by nanofiltration (NF), followed by spray drying to produce an undenatured pre-acidified whey protein isolate powder. The final composition of the undenatured pre-acidified whey protein isolate is illustrated in Table 1.

In the method of Example 1, both UF1 and UF2 were performed on standard UF membranes with a pore size in the range from 5 to 10 kDa. The MF was performed on a polymeric membrane with a pore size between 0.1 to 0.3 μm. The NF may be performed on polymeric membrane with a pore size between 150 and 300 Da.

As illustrated in Table 2, the undenatured pre-acidified whey protein isolate produced according to the present example not only exhibited a high solubility, as observed visually and as reflected in the turbidity of the below samples, over a wide pH-range, but also demonstrated excellent heat stability in solutions with a low pH (<3.5). The undenatured pre-acidified whey protein isolate also produced clear solutions with low viscosity (such as less than 10 cP, less than 7.5 cP, or even about 6.9 cP in an example at 25° C. or less for a 10 wt. % protein solution) in addition to having a neutral taste and a low fat and lactose content.

TABLE 1

| | TS | Protein | PDB | Ash | Fat | Lactose |
|---|---|---|---|---|---|---|
| pH | (%) | (%) | (%) | (%) | (%) | (%) |
| 3.3 | 96.2 | 88.7 | 92.2 | 2.3 | 0.3 | 1.5 |

*All percentages are percentages by weight of the product, except, PDB, which is percent by weight based on the total weight of solids.

TABLE 2
Turbidity and Heat Stability of Example 1:

| Turbidity of | Turbidity of | Turbidity of | Heat Stability* | Heat Stability | Heat Stability |
|---|---|---|---|---|---|
| 5% Protein | 7% Protein | 10% Protein | of 5% Protein | of 7% Protein | of 10% Protein |
| Solution | Solution | Solution | Solution (95° C., | Solution (95° C., | Solution (95° C., |
| (NTU) | (NTU) | (NTU) | 10 & 20 min) | 10 & 20 min) | 10 & 20 min) |
| 13.4 | 15.8 | 19.4 | Pass 20 min | Pass 20 min | Pass 10 min |

### Example 2

A protein fortified beverage was formed according to the following procedure. An undenatured pre-acidified whey protein isolate powder from Example 1 was dissolved in water with the ingredients shown in Table 3. The solution was then subjected to an ultra-heat treatment (UHT) using MicroThermics UHT system at 100° F. pre-heat and 200° F. final-heat for 30 seconds, followed by hot fill into bottles and cooled in ice water.

The protein fortified beverage prepared according to the example showed good clarity (turbidity <50 NTU, such as less than 47 NTU) with a low pH (<3.5, such as less than 3.4), which was conveniently achieved with direct use of undenatured pre-acidified whey protein isolate without the need of using any other additional acidulants.

TABLE 3
Protein Fortified Beverage Base Recipe:

| Ingredients | % (w/w) in Base Recipe |
|---|---|
| Pre-Acidified WPI | 4.51 |
| Sugar | 0.28 |
| Natural Flavor Sweet Modulator | 0.26 |
| Pineapple Coconut Flavor | 0.12 |
| Sodium Citrate | 0.08 |
| Natural Juicy Flavor | 0.03 |
| Water | 94.73 |
| Total | 100 |

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

1. A method of making an undenatured pre-acidified whey protein isolate, the method comprising:
ultrafiltering a liquid whey composition into a liquid whey protein retentate and a liquid whey permeate, wherein the liquid whey composition comprises sweet whey, acid whey, native whey, or combinations thereof, and the liquid whey protein retentate comprises greater than or about 5 wt. % total solids;
microfiltering the liquid whey protein retentate into a microfiltered whey protein retentate and a microfiltered whey protein permeate;
reducing a pH of the microfiltered whey protein permeate to a pH of less than 3.8, forming a reduced pH whey protein permeate;
ultrafiltering and diafiltrating the reduced pH whey protein permeate into the undenatured pre-acidified whey protein isolate; and
optionally nanofiltering the undenatured pre-acidified whey protein isolate.

2. The method of claim 1, further comprising spray drying the undenatured pre-acidified whey protein isolate, forming an undenatured pre-acidified whey protein isolate powder.

3. The method of claim 1, wherein the microfiltered whey protein permeate has a total solids content from about 1.5 wt. % to about 3.5 wt. %.

4. The method of claim 1, further comprising reverse osmosing the microfiltered whey protein permeate prior to reducing the pH.

5. The method of claim 4, wherein the microfiltered whey protein permeate has a total solids content from about 3.5 wt. % to about 6 wt. %.

6. The method of claim 1, wherein the liquid whey composition is obtained from a cheesemaking process.

7. The method of claim 1, wherein the ultrafiltering of the liquid whey composition does not include diafiltrating.

8. The method of claim 1, wherein the pH of the whey protein permeate is reduced to a pH of less than or about 3.5.

9. The method of claim 1, wherein the pH of the whey protein permeate is reduced utilizing a food-grade acidulant.

10. The method of claim 1, wherein the undenatured pre-acidified whey protein isolate comprises greater than or about 18 wt. % solids.

11. The method of claim 1, wherein the undenatured pre-acidified whey protein isolate comprises greater than or about 90 wt. % protein on a dry basis.

12. The method of claim 1, wherein the undenatured pre-acidified whey protein isolate comprises a pH of less than or about 3.5.

13. The method of claim 1, wherein the undenatured pre-acidified whey protein isolate comprises less than or about 5 wt. % ash.

14. The method of claim 1, wherein the undenatured pre-acidified whey protein isolate comprises less than or about 2 wt. % minerals.

15. The method of claim 1, wherein the undenatured pre-acidified whey protein isolate comprises from 0.5 wt. % to about 2 wt. % lactose.

16. The method of claim 1, wherein the undenatured pre-acidified whey protein isolate has a turbidity of less than or about 10 NTU at a solids content of greater than or about 15 wt. %.

17. A protein fortified beverage comprising:
from about 2 wt. % to about 10 wt. % of the undenatured pre-acidified whey protein isolate according to claim 1; and
water.

18. A method of making a protein fortified beverage, comprising:
ultrafiltering a liquid whey composition into a liquid whey protein retentate and a liquid whey permeate, wherein the liquid whey composition comprises sweet whey, acid whey, native whey, or combinations thereof, and the liquid whey protein retentate comprises greater than or about 5 wt. % total solids;
microfiltering the liquid whey protein retentate into a microfiltered whey protein retentate and a microfiltered whey protein permeate;
reducing a pH of the microfiltered whey protein permeate to a pH of less than 3.8, forming a reduced pH whey protein permeate;
ultrafiltering and diafiltrating the reduced pH whey protein permeate into an undenatured pre-acidified whey protein isolate;
optionally nanofiltering the reduced pH whey protein isolate to produce an optionally concentrated undenatured pre-acidified whey protein isolate; and
mixing the undenatured pre-acidified whey protein isolate or optionally concentrated undenatured pre-acidified whey protein isolate with a beverage.

19. The method of claim 18, wherein the protein fortified beverage exhibits a turbidity of less than or about 30 NTU at a concentration of 5 wt. % protein in the protein fortified beverage.

20. The method of claim 18, further comprising spray drying the undenatured pre-acidified whey protein isolate or optionally concentrated undenatured pre-acidified whey protein isolate prior to mixing with the beverage.

21. A protein fortified beverage comprising:
from about 2 wt. % to about 10 wt. % of an undenatured pre-acidified whey protein isolate; and
water; and
wherein the protein fortified beverage exhibits a turbidity of less than or about 30 NTU at a concentration of 5 wt. % protein in the protein fortified beverage.

22. The method of claim 1, wherein microfiltering the liquid whey protein retentate comprises a microfilter having a total membrane surface area of less than or about 600 square meters (m²) per 1,000 pounds of protein in the liquid whey composition.
